(19) United States
(12) Patent Application Publication
(10) Pub. No.: US 2024/0060366 A1
(43) Pub. Date: Feb. 22, 2024

(54) Device for Supporting a Ladder, and Method of Use

(71) Applicant: Patrick Godin, Vernon, CT (US)

(72) Inventor: Patrick Godin, Vernon, CT (US)

(21) Appl. No.: 17/892,287

(22) Filed: Aug. 22, 2022

(51) Int. Cl. E06C 5/24; E06C 7/42

(52) U.S. Cl. CPC E06C 5/24; E06C 7/42

(57) ABSTRACT

An apparatus is disclosed that comprises a hitch connector including a first end portion configured to be removably attached to a vehicle hitch, and a second end portion, and a ladder support including a central portion, an extension portion attached to the second end portion of the hitch connector, and first and second arms extending outwardly from the central portion. The first arm has an outer end portion with a first sleeve-shaped ladder bracket formed thereon, and the second arm has an outer end portion with a second sleeve-shaped ladder bracket formed thereon. The first and second ladder brackets are configured to receive lower leg portions of a ladder to position the ladder to extend upwardly and rearwardly at an angle in the range of 6 degrees to 13 degrees relative to a vertical plane when the hitch connector is attached to a vehicle hitch. In embodiments, the apparatus is configured to support a load of at least 300 pounds. Corresponding systems and methods also are disclosed.

### BACKGROUND

This disclosure relates generally to ladder supports, and more particularly to an adjustable ladder support.

The precise positioning of a ladder in an outdoor setting can limited by the contours of the underlying ground surface. In some cases, a ladder cannot be employed due to the lack of stable and even terrain at the desired location of use.

It would be advantageous to develop a system that would enable a ladder to be used near uneven ground surfaces.

### SUMMARY

One embodiment described herein is an apparatus comprising a hitch connector including a first end portion configured to be removably attached to a vehicle hitch, and a second end portion, and a ladder support including a central portion attached to the second end portion of the hitch connector, and first and second arms extending outwardly from the central portion. The first arm has an outer end portion with a first sleeve-shaped ladder bracket formed thereon, and the second arm has an outer end portion with a second sleeve-shaped ladder bracket formed thereon. The first and second ladder brackets are configured to receive lower leg portions of a ladder to position the ladder to extend upwardly and rearwardly at an angle in the range of 6 degrees to 13 degrees relative to a vertical plane when the hitch connector is attached to a vehicle hitch. In embodiments, the apparatus is configured to support a load of at least 300 pounds. In some cases, at least one of the first and second arms has an adjustable length.

In some configurations, the ladder support includes an extension portion pivotally attached to the second end portion of the hitch connector. The apparatus sometimes further comprises a stop component configured to allow for pivoting of the ladder support between at least a first position and a second position prior to use, and to prevent pivotal movement of the ladder support during use.

In some embodiments, the second end portion of the hitch connector includes parallel first and second flanges having first and second bores, the extension portion of the ladder support includes at least a third bore, and the apparatus includes a bolt extending through the first, second and third bores and a fastener, the bores, bolt and fastener being configured to allow the ladder support to pivot in a horizontal plane relative to the hitch connector during set-up.

In certain embodiments, the hitch connector includes a slanted portion between and first end portion and the second end portion, the slanted portion being configured to position the lower ends of the ladder brackets at a height below the first end portion of the hitch connector when the apparatus is in use. Sometimes the slanted portion extends downwardly at an angle of about 15 to about 25 degrees relative to a plane parallel to the length of the first end portion of the hitch connector in a direction from the first end portion to the second end portion.

Another embodiment is a method, comprising obtaining the apparatus described above, obtaining a ladder, attaching the first end portion of the hitch connector to a vehicle hitch, and mounting the legs of the ladder in the sleeve-shaped first and second ladder brackets. In embodiments, the method further comprises climbing the ladder. In some cases, the extension portion is pivotally attached to the second end portion of the hitch connector, and the method further comprises selecting a fixed horizontal pivotal position for the ladder support.

### BRIEF DESCRIPTION OF THE DRAWINGS

FIG. 1 shows a top perspective view of a first embodiment of an adjustable ladder support.

FIG. 2 illustrates a top perspective view of the first embodiment showing pivotal adjustment of the ladder support.

FIG. 3 shows a top perspective view of the first embodiment with the ladder support extended in width.

FIG. 4 shows a bottom perspective view of the first embodiment with the ladder support extended in width.

FIG. 5 shows a top perspective view of the first embodiment when in a non-extended and folded configuration for storage.

FIG. 6 shows the first embodiment connected to a trailer hitch.

FIG. 7 schematically shows a top view of the first embodiment.

FIG. 8 schematically shows a side view of the first embodiment.

FIG. 9 is an end view schematically showing the adjustable width detail of the first embodiment.

FIG. 10 shows a side perspective view of the first embodiment connected to a vehicle hitch and supporting a ladder.

FIG. 11 shows a top view of a second embodiment that does not pivot.

FIG. 12 shows a side view of the second embodiment.

### DETAILED DESCRIPTION

A sleeve system for supporting a ladder is provided in which the sleeves are mounted to a vehicle hitch. The hitch-mountable sleeve system enables a ladder to be used in locations with uneven or rough terrain, as well as in muddy and snowy areas. The user is not required to lean the ladder against a wall, gutter, tree or other structure. Instead, the legs of the ladder are mounted on sleeves that extend upwardly from a sleeve support that is mounted to a vehicle hitch. The device can be used by contractors, farmers homeowners, landscapers, recreation workers and others to access elevated areas of a tree or shrub, building, etc.

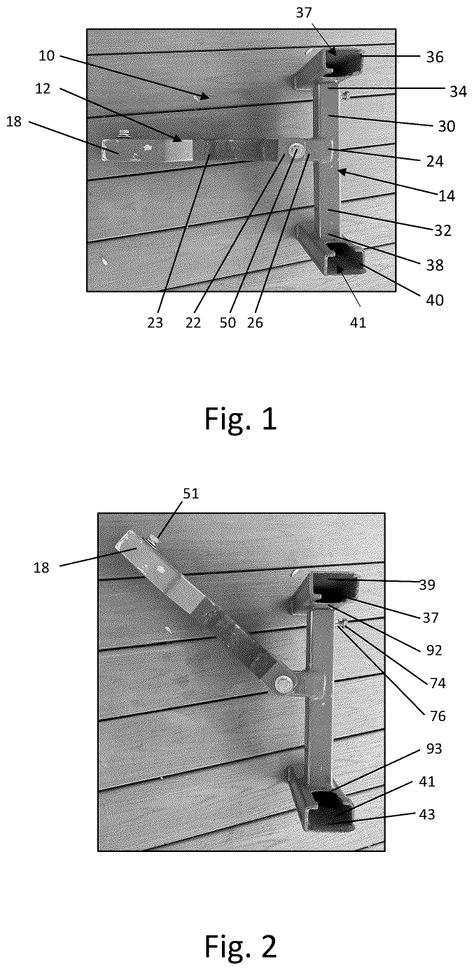

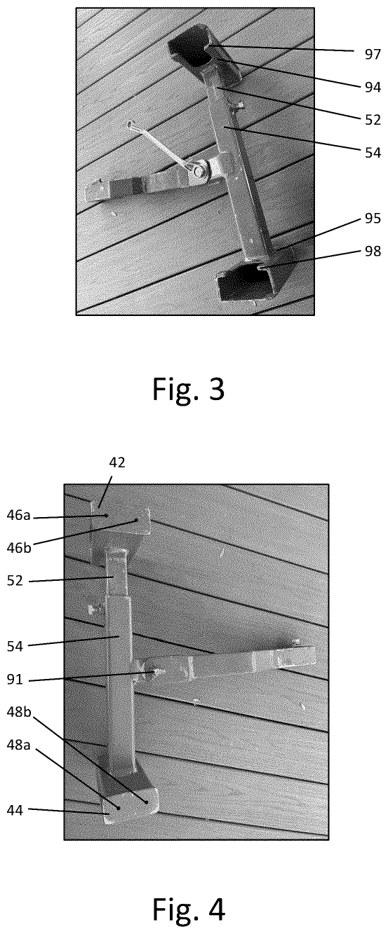

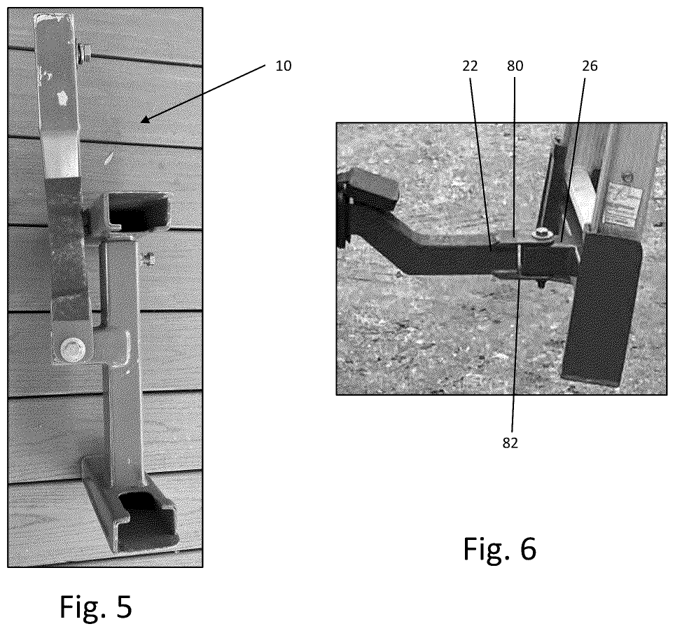

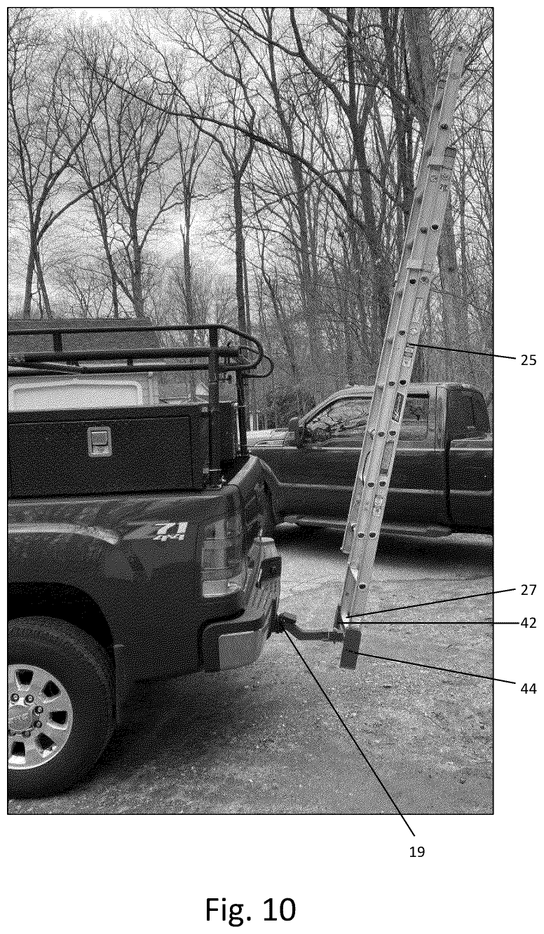

Referring to the drawings, FIGS. 1-10 show a device for supporting a ladder in an elevated position for use near uneven or unstable terrain. The device is generally designated as 10, and includes a hitch connector 12 pivotally attached to a ladder support 14. The hitch connector 12 includes a first end portion 18 configured to be removably attached to a vehicle hitch 20, and a second end portion 22. When the device 10 is in use, the second end portion 22 of the hitch connector optionally can be disposed at a lower height than the first end portion 18 by including a downwardly slanted intermediate portion 23, most clearly shown in FIGS. 1, 6 and 8. The degree of the slant depends in part on the height of the vehicle hitch 20, shown in FIG. 10, and the desired height of the ladder 25 above the ground, as in most cases it is desirable for a user to be able to conveniently step from the ground onto the lowest rung 27 of the ladder 25.

The ladder support 14 includes a central portion 24, an extension portion 26 pivotally attached to the second end portion 22 of the hitch connector 12 via an upper flange 80 and a lower flange 82 that are fixed to the second end portion of the hitch connector, and first and second arms 30, 32, respectively, extending outwardly from the central portion 24. The first arm 30 has an outer end portion 34 with a first sleeve-shaped ladder bracket 36 formed thereon, and the second arm 32 has an outer end portion 38 with a second sleeve-shaped ladder bracket 40 formed thereon. Each bracket has a rectangular side wall and a generally flat lower wall. In embodiments, the first and second arms 30, 32 are rigid. The first and second ladder brackets 36, 40 have first and second interior channels, 37, 41, respectively, defined by first and second interior walls, 39, 43, respectively, that are configured to receive lower leg portions 42, 44, respectively of a ladder 25 to position the ladder 25 to extend upwardly and rearwardly at an angle in the range of 6 degrees to 13 degrees, or 7 to 11 degrees, or 8 to 10 degrees, relative to a vertical plane when the hitch connector 12 is attached to a vehicle hitch 20 and the first end portion 18 of the hitch connector 12 is extending generally horizontally. In order to fix the pivotal position of the ladder support 14 (usually) before the ladder 25 is mounted in the ladder brackets 36, 40, a stop component 50 is incorporated. In the embodiment shown in the figures, the stop component 50 is a bolt. In some cases, the stop component is a toggle, latch, or other mechanism that allows for fixing the apparatus in a selected pivotal position.

The device 10 has dimensions, and is formed from materials, that render it capable of supporting a load of about 300 pounds to about 500 pounds, or about 325 to about 475 pounds, or about 350 pounds to about 450 pounds, including the weight of both the ladder 25 and the person climbing the ladder 25. In some cases, the device 10 is adapted to attach to a trailer hitch with a tongue weight of about 10,000 pounds to about 30,000 pounds, or about 15,000 pounds to about 25,000 pounds. In some cases, the device has an overall length of about 16 inches to about 28 inches, or about 17 to about 26 inches, or about 18 to about 25 inches. In embodiments, the first end portion 18 of the hitch connector 12 has a length in the range of about 3 inches to about 8 inches, or about 4 inches to about 7 inches. In some cases, the slanted intermediate portion has a length of about 4 inches to about 7 inches, or about 5 inches to about 6 inches. In embodiments, the second end portion 22 has a length of about 6 inches to about 14 inches, or about 8 inches to about 13 inches, or about 9 inches to about 12 inches. In some cases, the extension portion 26 of the ladder support 14 has a length of about 3 inches to about 8 inches, or about 4 inches to about 7 inches. In embodiments, the hitch connector 12 and the ladder support 14 are made from 1½ inch, or 2 inch, or 3 inch square metal tubing. Circular tubing also can be used, or a combination of rectangular or square and circular tubing.

The angled portion of the hitch connector 12 typically has an angle of about 15 degrees to about 25 degrees, or about 17 degrees to about 23 degrees, or about 18 to about 22 degrees, relative to the longitudinal axis of the first end portion of the hitch connector. The angled portion is downwardly angled in a direction from the first end portion to the second end portion of the hitch connector. In embodiments, the first end portion 18 and the second end portion 22 of the hitch connector are generally parallel to one another and are configured to extend generally horizontally when the device 10 is connected to a vehicle hitch 20.

The first end portion 18 of the hitch connector 12 has a rectangular cross section and includes a bore 49 extending in a direction generally perpendicular to the length of the hitch connector 12. The bore is configured to receive a bolt 51 that connects the hitch connector 12 to the vehicle hitch 20.

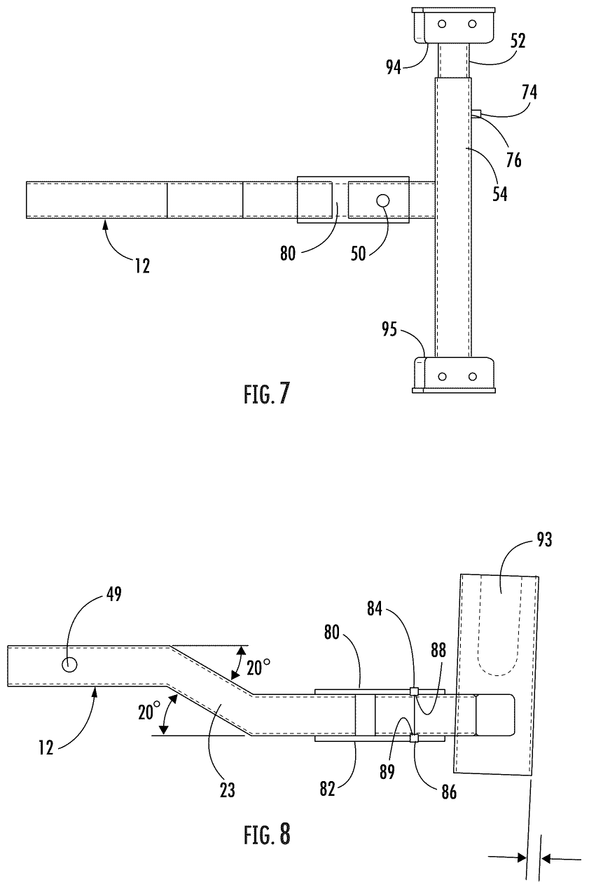

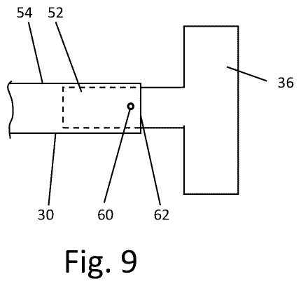

In the embodiment shown in FIGS. 1-10, the first arm 30 of the ladder support 14 has an adjustable length in order to accommodate ladders 25 of varying widths. The illustrated embodiment shows the first arm 30 having an inner telescoping portion 52 and an outer telescoping portion 54. FIG. 7 schematically shows the first arm 30 when it is in a partially extended configuration. In order to adjust the length of the first arm 30, the inner telescoping arm is slid longitudinally, and a bolt 74 is adjusted in aperture 60, which is formed in outer telescoping member 54 near terminal edge 62 as shown in FIG. 9, to allow for sliding. The bolt 74 is held with a fastener 76 to fix the relative position of inner telescoping portion 52 and outer telescoping portion 54. When the ladder is inserted into the first sleeve-shaped ladder bracket 36 and the second sleeve-shaped ladder bracket 40, the bolt 74 is then tightened for stabililty, with the distal end of the bolt contacting the outer surface of the inner telescoping member 52. Other suitable mechanisms alternatively can be used to adjust the length of the first arm 30. In some cases, as shown in FIGS. 1-10, the length of only the first arm 30 is adjustable. In some cases, the lengths of both the first arm 30 and the second arm 32 are adjustable.

Various configurations can be used to provide for horizontal pivoting of the ladder support 14 relative to the hitch connector 12. In embodiments, the second end portion 22 of the hitch connector 12 includes parallel first and second flanges 80, 82, having first and second bores 84, 86, respectively. The first and second flanges 80, 82 extend longitudinally outwardly forming part of the second end portion 22 of the hitch connector, and, in the embodiment shown in the figures, are horizontally disposed. The extension portion 26 of the ladder support 14 is configured to fit in between the parallel first and second flanges 80, 82. The extension portion 26 of the ladder support 14 includes a third bore 88 on its upper surface and a fourth bore 89 on its lower surface. The apparatus further comprises a stop component 50 such as a bolt extending through the first bore 84, second bore 86, third bore and fourth bore and is secured in place with a fastener 91, with the bores, bolt and fastener being configured to allow the ladder support 14 to pivot in a horizontal plane relative to the hitch connector 12 prior to use and to be fixed in a stationary pivotal position during use.

In some cases, the channels 37, 41 in the ladder brackets 36, 40 are configured to receive ladder legs having a horizontal depth of about 3-4 inches and a horizontal width of about 1-2 inches. In some cases, the ladder brackets have a vertical height of about 7 inches to about 14 inches, or about 8 inches to about 12 inches, or about 9 inches to about 10 inches such that they contact about 7 inches to about 14 inches, or about 8 inches to about 12 inches, or about 9 inches to about 10 inches of the vertical height of the ladder legs at their lower end.

The first arm 30 and second arm 32 of the device 10 have lengths configured to provide a space in the range of about 9 inches to about 22 inches, or about 11 inches to about 20 inches, or about 12 inches to about 18 inches between the exterior surfaces 94 and 95 of the inner walls 97, 98 of the ladder brackets 36, 40. In most cases, the device 10 is configured for use with ladders having a height of 6 feet to 22 feet, or 10 feet to 20 feet, and a width, as measured along the outer sides at the bottom of the ladder, of 12 inches to 24 inches, or 14 inches to 20 inches, or 15 inches to 19 inches. When the ladder support is pivotable, in some cases there are an unlimited number of pivot positions available between about 15 degrees and about 345 degrees relative to the axis of the firm arm 30. In other cases, such as if a toggle is used, there are 2 to 5 pivot positions available, or 3 to 4 pivotable positions available, for example at 45 degrees, 90 degrees, and 135 degrees between the hitch connector 12 and the first arm 30. In embodiments, the hitch connector is configured for use with a 2 inch by 2 inch trailer hitch. In most cases, the hitch connector 12 is hollow and has a rectangular cross section. In embodiments, the ladder support 14 is formed from hollow tubes that have a square or rectangular cross section. In some cases, both the first and second arms comprise hollow rectangular tubes. In most cases, the vehicle hitch 20 comprises a rectangular cross-sectional tube sized to receive the first end portion 18 of the hitch connector 12.

In embodiments, the hitch connector 12 and ladder support 14 comprise metal. In some cases, the hitch connector and ladder support comprise steel. In certain embodiments, solid steel grade ASTM A500B is used for the hitch connector and ladder support, and high-grade steel ASTM A36 is used for the ladder brackets 36 and 40. In some cases, the device 10 is coated with a durable coating. Any weather-resistant and generally scratch-resistant coating can be used. For example, the coating can be a powder coat comprising a metal filled thermoplastic or thermoset material. In embodiments, the coating is a powder coating, such as Polyester Powder TGIC TRIGLYCIDYL. In some cases, the bolts 51, 74 and 90 are grade 8 bolts. When the hitch connector 12 and ladder support are fabricated, in most cases, the welds are formed using Filler Weld E70XXLH Electrodes.

The embodiment of the device 10 shown in the figures is configured such that neither the device 10, nor a ladder 25 mounted thereon for use, is in contact with the ground. Thus, the ladder 25 is elevated during use. This configuration enables the ladder 25 to be used to access locations above ground that is unstable or uneven, or is covered by shrubs, trees or other obstacles that prevent stable mounting of the ladder 25 directly on the ground itself.

In some cases, as is shown in the figures, the first and second sleeve-shaped ladder brackets 36, 40, have vertically extending first and second slots 92, 93, respectively in the first and second inner sides 94, 95 of the ladder brackets 36, 40 that are configured to receive the lowest rung 27 of the ladder 25. The slots 92, 93 are particularly useful when the ladder is an extension ladder. In most cases, the lower end 42 of the first ladder bracket 36 has liquid drainage holes 46a and 46b, and the lower end 44 of the second ladder bracket 40 has liquid drainage holes 48a, 48b, to allow for water to exit the interior space in the brackets 36, 40.

FIG. 10 shows a system that includes a vehicle 96 having a vehicle hitch 20 with the device 10 mounted to the hitch. A ladder 25 is mounted to the device 10.

In order to use the device 10, the first end portion 18 of the hitch connector 12 is attached to a vehicle hitch 20. A desired pivotal position for the ladder support 14 is selected and the ladder support 14 is fixed in this position. The ladder 25 is lifted and its lower leg portions 42, 44 are removably mounted in the sleeve-shaped first and second ladder brackets 36, 40. The bolt 74 is tightened to fix the slidable position of the inner telescoping member. Once the ladder 25 has been securely mounted, a user can climb the ladder to perform necessary work. When the work is finished, the user climbs down the ladder 25, removes the lower leg portions 42, 44 of the ladder 25 from the ladder brackets 36, 40, and removes the device 10 from the vehicle hitch 20. The device 10 is designed to be particularly well-suited for use in conjunction with a metal ladders, such an aluminum ladder. In some cases, the device 10 can be used to transport a ladder between work sites.

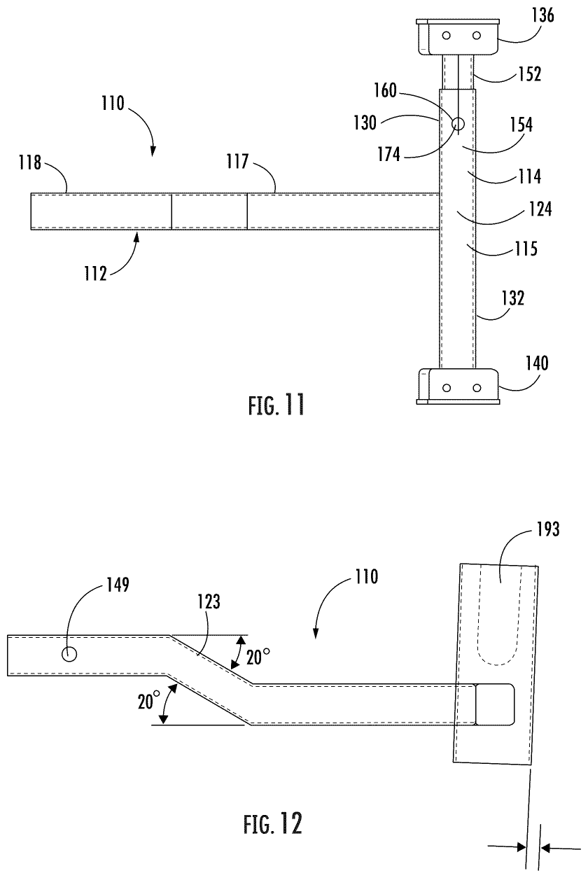

FIGS. 11-12 show a second embodiment of an adjustable ladder support that it not pivotable. This device is generally designated as 110. In this embodiment, a hitch connector 112 is rigidly connected to a ladder support 114. A downwardly slanted intermediate portion 123 is included between the hitch connector 112 and the ladder support 114. In most cases, the hitch connector 112 and the extension portion of the ladder support 114 are permanently attached, forming an elongated component 117. The first and second arms 130, 132 and the central portion 124 can be formed from a straight telescoping elongated member 115 that is welded to the elongated component 117 that forms the hitch connector 112 and extension portion. This embodiment includes a first end portion 118 of the hitch connector 112 that is configured to attach to a vehicle hitch using a bolt configured to extend through a bore 149. The first arm 130 and second arm 132 of the ladder support 114 are similar to those of the first embodiment. The first arm 130 has an outer end portion with a first sleeve-shaped ladder bracket 136 formed thereon, and the second arm 132 has an outer end portion with a second sleeve-shaped ladder bracket 140 formed thereon. The first arm 130 is formed from an inner telescoping member 152 and an outer telescoping member 154. The second arm 132 is formed from the outer telescoping member 154. The relative positions of the inner telescoping member 152 and outer telescoping member 154 are fixed using a bold 174 extending through an aperture 160 in the outer telescoping member. Each ladder bracket includes a slot, one of which is shown in FIG. 12 as 193, configured to receive the lowest rung of an extension ladder. The first and second ladder brackets 136, 140 are configured to receive lower leg portions of a ladder (not shown) to position the ladder to extend upwardly and rearwardly at an angle in the range of 6 degrees to 13 degrees, or 7 degrees to 11 degrees, or 8 degrees to 10 degrees, relative to a vertical plane when the hitch connector 112 is attached to a vehicle hitch.

The dimensions of the device 110 are generally the same as the dimensions of the device 10 described above. The advantages of the second embodiment are that it can be manufactured at lower cost than the first embodiment, and in some cases may be able to support a higher load than the first embodiment.

A number of alternatives, modifications, variations, or improvements therein may be subsequently made by those skilled in the art, which are also intended to be encompassed by the following claims.

What is claimed is:

1. An apparatus, comprising:
a hitch connector including a first end portion configured to be removably attached to a vehicle hitch, and a second end portion, and
a ladder support including a central portion attached to the second end portion of the hitch connector, and first and second arms extending outwardly from the central portion, the first arm having an outer end portion with a first sleeve-shaped ladder bracket formed thereon, the second arm having an outer end portion with a second sleeve-shaped ladder bracket formed thereon, the first and second ladder brackets being configured to receive lower leg portions of a ladder to position the ladder to extend upwardly and rearwardly at an angle in the range of 6 degrees to 13 degrees relative to a vertical plane when the hitch connector is attached to a vehicle hitch,
the apparatus being configured to support a load of at least 300 pounds.

2. The apparatus of claim 1, wherein at least one of the first and second arms has an adjustable length.

3. The apparatus of claim 1, wherein the ladder support includes an extension portion pivotally attached to the second end portion of the hitch connector.

4. The apparatus of claim 3, further comprising a stop component configured to allow for pivoting of the ladder support between at least a first position and a second position prior to use, and to prevent pivotal movement of the ladder support during use.

5. The apparatus of claim 1, wherein the second end portion of the hitch connector includes parallel first and second flanges having first and second bores, the extension portion of the ladder support includes at least a third bore, and the apparatus further comprises a bolt extending through the first, second and third bores and a fastener, the bores, bolt and fastener being configured to allow the ladder support to pivot in a horizontal plane relative to the hitch connector during set-up.

6. The apparatus of claim 1, wherein the hitch connector includes a slanted portion between and first end portion and the second end portion, the slanted portion being configured to position the lower ends of the ladder brackets at a height below the first end portion of the hitch connector when the apparatus is in use.

7. The apparatus of claim 6, wherein the slanted portion extends downwardly at an angle of about 15 to about 25 degrees relative to a plane parallel to the length of the first end portion of the hitch connector in a direction from the first end portion to the second end portion.

8. The apparatus of claim 3, wherein the hitch connector includes a slanted portion between and first end portion and the second end portion, the slanted portion being configured to position the lower end of the ladder brackets at a height below the first end portion of the hitch connector when the apparatus is in use.

9. The apparatus of claim 8, wherein the slanted portion extends downwardly at an angle of about 15 to about 25 degrees relative to the first end portion of the hitch connector in a direction from the first end portion to the second end portion.

10. The apparatus of claim 1, wherein the hitch connector and ladder support comprise metal.

11. The apparatus of claim 1, wherein the hitch connector and ladder support comprise steel.

12. The apparatus of claim 1, wherein the apparatus is entirely elevated from the ground during use.

13. The apparatus of claim 1, wherein the first and second sleeve-shaped ladder brackets each have an inner slot configured to receive a lower rung of a ladder.

14. The apparatus of claim 1, wherein the first and second sleeve-shaped brackets are configured to receive legs of an extension ladder.

15. The apparatus of claim 1, wherein the ladder brackets include liquid drainage holes on the lower ends thereof.

16. A system comprising a vehicle having a hitch with the apparatus of claim 1 mounted thereon.

17. The system of claim 16, further including a ladder mounted to the apparatus.

18. A method, comprising:
obtaining the apparatus of claim 1,
obtaining a ladder,
attaching the first end portion of the hitch connector to a vehicle hitch, and
mounting the legs of the ladder in the sleeve-shaped first and second ladder brackets.

19. The method of claim 18, further comprising climbing the ladder.

20. The method of claim 18, wherein the extension portion is pivotally attached to the second end portion of the hitch connector, the method further comprising:
selecting a fixed horizontal pivotal position for the ladder support.
